(19) United States
(12) Patent Application Publication
(10) Pub. No.: US 2010/0232977 A1
(43) Pub. Date: Sep. 16, 2010

(54) Height Adjustable Wind Turbine Nacelle

(75) Inventors: Morten Mogensen, Bramming (DK); Carsten Bruun Andersen, Arhus V (DK)

Correspondence Address: COHEN, PONTANI, LIEBERMAN & PAVANE LLP, 551 FIFTH AVENUE, SUITE 1210, NEW YORK, NY, 10176, US

(73) Assignee: Vestas Wind Systems A/S, Randers SV (DK)

(21) Appl. No.: 12/722,923

(22) Filed: Mar. 12, 2010

(30) Foreign Application Priority Data
Mar. 13, 2009 (DK) PA 200900364

(51) Int. Cl. B63H 1/28; B23P 6/00

(52) U.S. Cl. 416/246; 29/889.1

(57) ABSTRACT

A nacelle for a wind turbine, which nacelle has a height in its installed position, comprising a bottom part having a bottom face and two opposite side faces defining a space between the bottom and side faces and the bottom part width and a top part having a top face. Together, the faces define a nacelle cover within which wind turbine components can be housed. The nacelle cover has two intermediate parts intermediate the side faces and the top face. The invention also relates to a replacement kit and a replacement method.

### RELATED APPLICATIONS

This application claims priority from Denmark Patent Application Serial Number PA 200900364 which was filed on Mar. 13, 2009.

### BACKGROUND OF THE INVENTION

1. Field of the Invention

The present invention relates to a nacelle for a wind turbine, which nacelle has a height in its installed position, comprising a bottom part having a bottom face and two opposite side faces defining a space between the bottom and side faces and the bottom part width and a top part having a top face. Together, the faces define a nacelle cover within which wind turbine components can be housed.

2. Description of the Related Art

A wind turbine nacelle is manufactured having a certain height depending on the size of the wind turbine components, e.g. drive train, gearbox, generator, etc., to be housed inside the nacelle. The nacelle cover is made in two parts, enabling the drive train to be inserted in the bottom part by means of a crane, after which the roof top is arranged providing a closure of the cover.

When manufacturing wind turbine nacelles, wind turbine nacelles of varying sizes must be manufactured in order to comply with the need of the customers. At the manufacturing site, the parts are produced in moulds, and moulds of many sizes are thus required. A disadvantage of having parts of different sizes is thus that several large moulds must be handled at the manufacturing site.

Thus, there is a need for a more simple form of production of wind turbine nacelles which minimises the handling time by reducing the number of large moulds to be handled.

When performing some kind of repair work in a wind turbine nacelle, extra room above the drive train may be needed, and the crane is used to lift the roof top during the operation. If repair work is to be performed on an offshore wind turbine, the crane is shipped from shore on a specially built ship.

Repair work on wind turbines both on shore and offshore can be difficult, and also very expensive. Furthermore, the weather conditions may hinder the performance of any repair work at all.

### SUMMARY OF THE INVENTION

An object of the present invention is, at least partly, to overcome the above disadvantages and drawbacks of the prior art and to provide an improved wind turbine nacelle which is easier to produce.

An additional object of the present invention is to provide an improved wind turbine nacelle which is easier to repair when extra height is needed for the repair job, e.g. when part of the drive train is to be lifted in order to perform the repair work.

The above object, together with numerous other objects, advantages, and features, which will become evident from the below description, is accomplished by a solution in accordance with the present invention by a nacelle for a wind turbine, which nacelle has a height in its installed position, comprising:

a main frame structure,
a bottom part connected with the main frame structure and having a bottom face and two opposite side faces defining a space between the bottom and side faces and the bottom part width, and
a top part having a top face,
   the faces together defining a nacelle cover within which wind turbine components can be housed,
   wherein the nacelle cover has two intermediate parts intermediate the side faces and the top face.

By having two intermediate parts, the wind turbine nacelle can be adjusted in height so as to comply with the different sized wind turbine nacelle and thus no different sized mould is needed. Thus, it is possible to make different sized nacelles only by using different sized intermediate parts. A further advantage is that the internal volume of the nacelle may be adapted to the components to be housed in the nacelle simply by adjusting the height of the nacelle.

In addition, it may be needed to replace the components in an already installed wind turbine with other, but larger components, such as a larger generator or other larger parts of the drive train. This can easily be facilitated by attaching new intermediate parts of a height corresponding to the new equipment.

Furthermore, when performing repair work on the drive train, it may be useful to have more space above the drive train to be able to lift up the drive train or to replace certain parts. In this case, the intermediate parts are separated from the top face and the top face is lifted upwards, still serving as a roof so that the drive train is protected from rain and dirt.

In one embodiment of the nacelle, the top face may be movable between a first position in which the nacelle has a first height and a second position in which the nacelle has a second height.

Thus, the height of the nacelle can be set to any height between the first and the second heights.

Furthermore, at least one of the intermediate parts may be adjustable to adjust a height of the intermediate part.

By adjusting the height of the intermediate parts, it is possible to increase the height of the nacelle. If the height adjustment is temporary, the height of the nacelle may easily be decreased again by adjusting the height of the intermediate parts back. If the top face is supported alone by the intermediate parts, a permanent height adjustment of the nacelle is thus performed.

In one embodiment, the intermediate part may comprise a displaceable second intermediate part arranged to move as a prolongation of the intermediate part in order to adjust the height of the intermediate part.

The second intermediate part may e.g. be arranged on the inside of the intermediate part, and it may be quickly and easily displaceable to adjust the height of the nacelle. As the adjustment of the height of the nacelle is performed by displacement of the second intermediate parts, the nacelle cover thus remains intact, protecting the interior of the nacelle from rain and dirt.

The nacelle may comprise a support structure arranged in connection with the main frame structure to support the top face at least in the second height.

When the support structure is connected to the internal frame structure, it is ensured that the support structure is firmly attached and is able to safely uphold the top part.

In one embodiment, the support structure may be adjustable so as to adjust the height of the nacelle by moving the top part between the first and the second position.

The support structure carries the top part. When the support structure is adjustable, it is thus possible to adjust the height of the nacelle by adjusting the support structure and replacing the intermediate parts.

In another embodiment, the support structure may have a predetermined height, either in order to fit a maximum transportation height defined by certain countriesy or in order to be able to fit a standard drive train into the nacelle.

There are a number of rules and requirements relating to the size and design of a wind turbine nacelle. When the support structure is manufactured with a predetermined height, it is thus easy to adapt the height of the nacelle to fit these requirements.

In one embodiment, an internal overhung crane structure is part of the frame structure.

A nacelle usually comprises some kind of crane. Using the frame structure both as an internal overhung crane structure and as support of the support structure reduces the number of parts needed in the nacelle, and thus the number of parts to be manufactured, maintained, and replaced.

In another embodiment, the frame structure may consist of individual rafters arranged at a predetermined distance along the side faces.

The first height of the nacelle may be lower than the second height of the nacelle.

In one embodiment, the first height may be a transportation height, e.g. below 4.0 metres or even below 3.3 metres.

Thus, the nacelle is able to pass under any brigde and through any tunnel in Europe when transported on a truck bed.

The second height may be the height of the nacelle when installed.

In an additional embodiment, a first side portion of the intermediate parts is connected to the top part and a second opposite side portion of the intermediate parts are slidable in relation to the side faces.

Hereby is obtained that the second ends of the intermediate parts are overlapping the side faces, either on the inside or outside, and may be displaced in relation of the side faces in view of the intended height of the nacelle.

Furthermore, the top face or a part of the top face may be movable in relation to the intermediate parts, whereby the inside height of the nacelle may be increased at predetermined areas in view of an instantaneous height requirement.

The invention also relates to a replacement kit comprising two intermediate parts as described above.

In one embodiment, the replacement kit further comprises a drive train part.

Finally, the invention also relates to a replacement method for replacement of parts within the nacelle comprising the steps of:

detaching the two intermediate parts having a first height and

attaching two new intermediate parts having a second height.

In addition, the replacement method may further comprise the step of:

detaching the top part of the nacelle.

Finally, the replacement method may further comprise the step of:
detaching part of the drive train.

### BRIEF DESCRIPTION OF THE DRAWINGS

In the drawings:

The invention and its many advantages will be described in more detail below with reference to the accompanying schematic drawings which, for the purpose of illustration, show some non-limiting embodiments and in which

FIG. 1 shows an exploded view of a wind turbine nacelle,

FIG. 2 shows a partly cross-sectional view of the nacelle of FIG. 1,

FIG. 3 shows a partly cross-sectional view of the nacelle without an intermediate part,

FIG. 4 shows a sectional view of FIG. 2,

FIG. 5 shows the support structure of FIG. 4 wherein the support structure has been replaced with a longer support structure,

FIG. 6 shows a sectional view of a nacelle having a height adjustable support structure, and

FIG. 7 shows the support structure of FIG. 6 wherein the support structure has been adjusted in height.

All the drawings are schematic and not necessarily to scale, and they show only those parts necessary to elucidate the invention, other parts being omitted or merely suggested.

### DETAILED DESCRIPTION OF THE PRESENTLY PREFERRED EMBODIMENTS

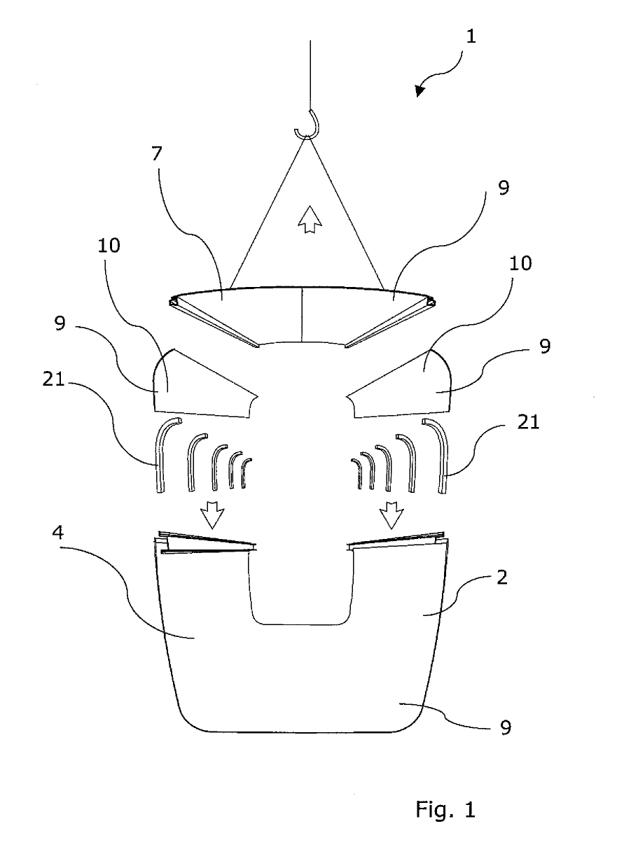

A wind turbine nacelle is shown in FIG. 1. When a wind turbine nacelle 1 is installed, the nacelle is positioned on a tower (not shown) and connected to three rotor blades through a hub (not shown) in a front end of the nacelle. The hub with rotor blades is always turned to face the wind and the turning movement is performed in a yaw of the bottom of the wind turbine nacelle 1 in the connection with the tower. The nacelle 1 is usually constructed having an internal main frame structure 12 comprising a bottom frame extending from the yaw, which bottom frame supports the nacelle, the hub, and the rotor blades. The nacelle 1 has a cover 9 in order to protect the interior parts of the nacelle, such as the generator, the gear, etc., which parts together is called the drive train. In this way, the weight of the nacelle, the hub, and the rotor blades is distributed by the bottom structure to the tower.

The cover 9 is fastened to the frame, typically to the bottom of the frame, and the cover is a self-supporting construction carrying its own weight.

A wind turbine nacelle 1 according to the present invention has a bottom part 2, an end part 30, and a top part 6. The bottom part 2 has two opposing side faces 4, and the top part 6 has a top face 7 connected to a set of support rails 20.

In production, the bottom part 2 and the top part 6, respectively, can be produced having the same measures for wind turbine nacelles of different sizes, due to the fact that the size of the wind turbine nacelle can be adjusted simply by manufacturing differently sized intermediate parts. Thus, the production of the wind turbine nacelles is made easier and the number of large moulds needed is substantially decreased. Handling of the large moulds is also decreased since only one size of moulds are needed for producing various sizes of top and bottom parts, respectively, a change of mould thus no longer being required when producing a wind turbine nacelle of a different size.

Furthermore, it is possible to produce differently sized intermediate parts in advance so that the size of the nacelle is not determined until the nacelle is assembled, and not when producing the top and bottom parts. This is useful if the customers e.g. have not yet determined whether they want a 2 MW wind turbine or a 3 MW wind turbine and which additional features or components are to be installed inside the nacelle.

In addition, the production of the wind turbine nacelle is more flexible in that change of nacelle size can easier be performed.

When being able to adjust the height of the nacelle by changing the intermediate parts, height adjustment of the nacelle can also be facilitated in order to allow room for repair work. This may e.g. be the case if part of the drive train needs to be separated from the rest of the drive train in order to perform the work. If the work takes more than a few hours, the interior of the nacelle 1 has to be closed off against incoming rain or dirt in the outside air, and lifting off the top face 7 is thus no longer suitable.

Sometimes, parts of the drive train need to be replaced in older wind turbines, and the spare parts may then no longer fit into the wind turbine nacelle 1. Thus the height of the nacelle 1 must be adjusted accordingly to comply with the new height of the drive train in order to fix the wind turbine again.

In these circumstances, a height adjustment of the nacelle 1 is needed. In order to adjust the height of the nacelle 1, the nacelle cover 9 has two intermediate parts 10 intermediate the side faces 4 and the top face 7. By having the two intermediate parts 10, the adjustment can be made by replacing the two intermediate parts with two higher intermediate parts. In another embodiment, the adjustment can be made by taking off the intermediate parts, and the height adjustment may be performed using additional equipment.

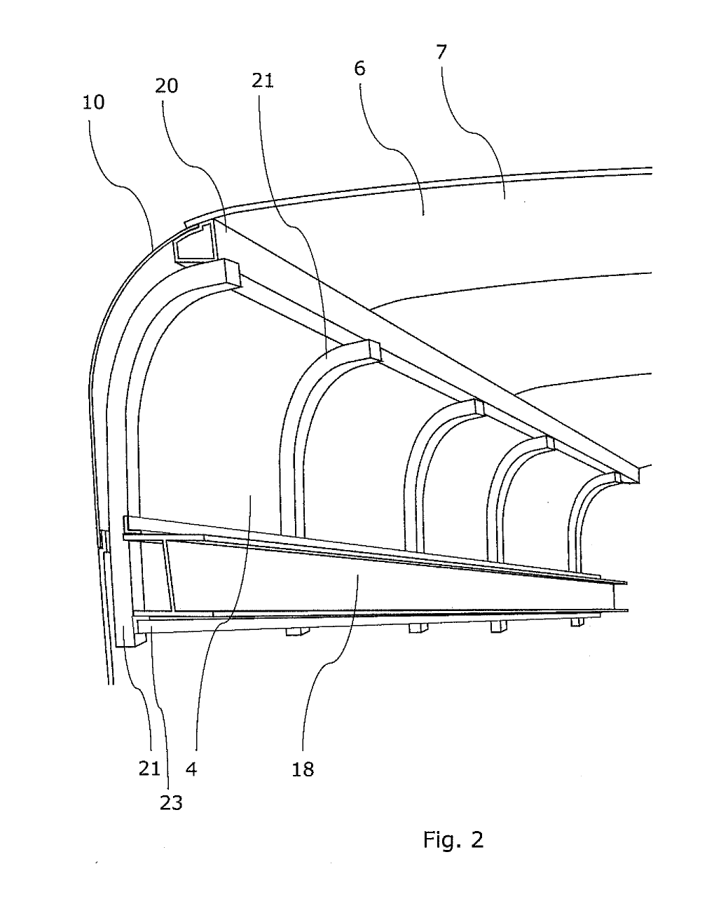

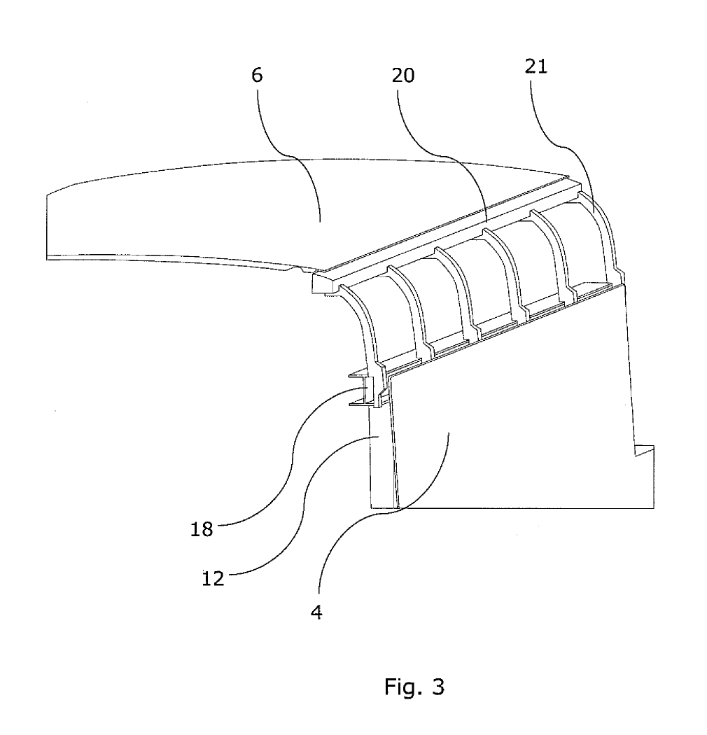

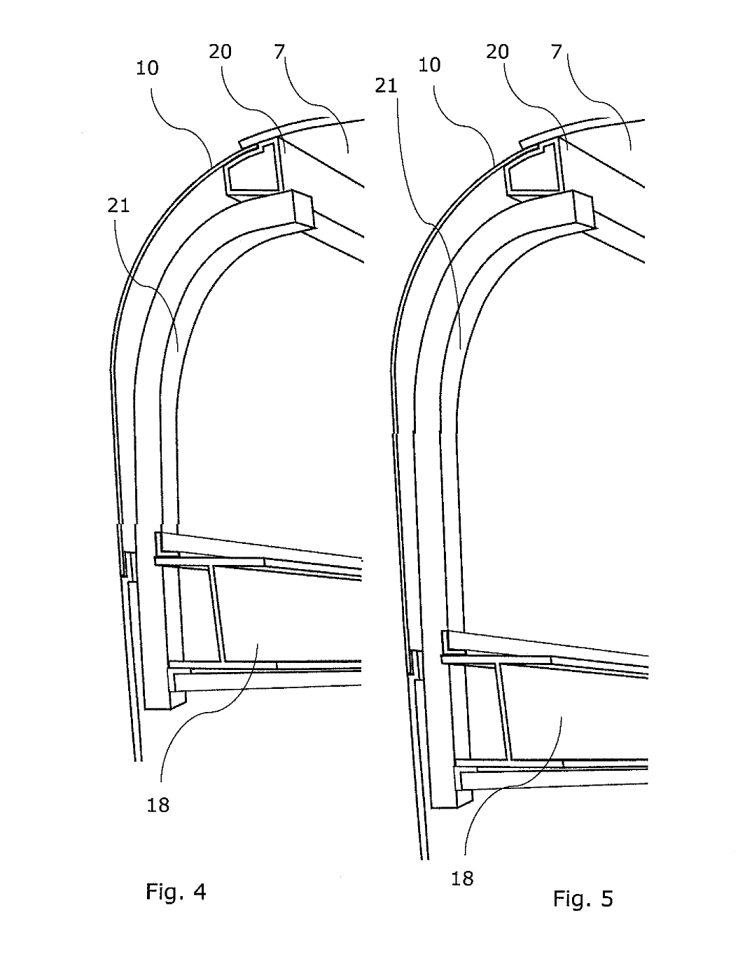

As shown in FIG. 2, the top face 7 is supported by a connection rail 20, which again is supported by a plurality of rafters 21. The rafters 21 are connected with a support beam 18, which may be part of the frame structure 12. The support beam 18 may also be fastened directly to the side face 4 by means of brackets 23 or the like fastening means. During adjustment of the height, the top face 7 and the end parts are separated from the bottom part and, subsequently, the intermediate parts 10 are removed as shown in FIG. 3. Subsequently, the rafters 21 are replaced with longer rafters 21 as shown in FIGS. 4 and 5.

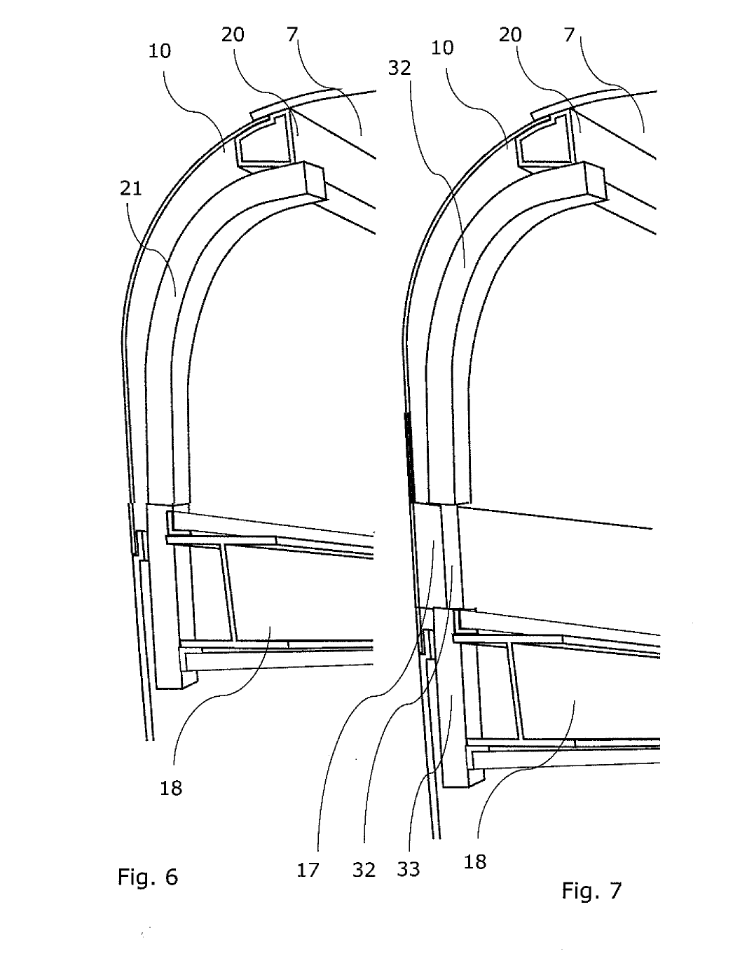

In another embodiment, the height adjustment is performed by prolonging each rafter 21 as shown in FIGS. 6 and 7. When adjusting the height of the rafters 21, the intermediate parts 10 are no longer long enough to seal off the interior of the nacelle. If the height adjustment is performed as a more permanent adjustment, the intermediate parts 10 are thus replaced with higher parts 10 as shown in FIG. 5, or a second intermediate part 17 may be inserted as shown in FIG. 7.

In addition, the intermediate parts 10 may also be adjustable in height. In this case, the intermediate part 10 has a second displaceable intermediate part, which is arranged in a slidable manner in relation to the first intermediate part 10, e.g. positioned on rails on the inner side of the first intermediate part. When the adjustment is needed, the top face 7 is lifted or the rafters 21 are prolonged, and the second intermediate part is slid into the gap between the intermediate part 10 and the top face 7 or the side face 4.

When having adjustable intermediate parts 10, the rafters 21 are not needed for height adjustment. If the top face 7 is supported directly by the intermediate parts 10, the rafters 21 are not needed at all.

The intermediate parts 10 may also be prolonged in other ways. In one embodiment, a part of the intermediate part 10 is divided into elongated sections, which part of the intermediate part will appear and fill out the gap when the intermediate part is drawn downwards, kind of like a sectional door.

In another embodiment, a part of the intermediate part 10 may have a folded part so that, when the intermediate part is stretched by a downwardly pull, that part is unfolded to fill out the gap.

As shown in FIGS. 6 and 7, the adjustable support structure, which is in the form of at least one rafter 21, is adjustable in height by means of a threaded shaft 31 in one part 32 of the rafter engaging a nut in the other part 33 of the rafter. Furthermore, the one part 32 of the support structure may be divided from the other part 33 by means of a telescopic joint. The adjustment can also be performed by means of hydraulic or a linear actuator.

In case of a temporary height adjustment, the intermediate parts 10 may hang freely in a hinge connected to the top face 7 which is supported by the support structure. In this way, the intermediate parts need not be removed, a process which has to be performed from outside the nacelle and demands a crane or the like equipment.

In another embodiment, the top face 7 has a displaceable part to cover the gap from the height adjustment.

When adjusting the height temporarily, only some of the rafters 21 have to be adjusted, as the adjustment in some cases may occur only in one side of the nacelle.

Even though the nacelle is shown having one shape, it may have a variety of shapes. Accordingly, the top and bottom parts may have different shapes than those shown in the drawings.

Even though the adjustment of the height is explained primarily as an adjustment from a lower height to a higher height, the opposite may also occur. For example, during transport of the nacelle, it may be necessary to decrease the height of the nacelle in order to comply with some transportation rules, e.g. to be able to transport the nacelle under a bridge or through a tunnel.

By a wind turbine is meant any kind of apparatus able to convert wind power into electricity, such as a wind generator, wind power unit (WPU), or wind energy converter (WEC). And by a wind turbine nacelle is meant any kind of housing housing the drive train of the wind turbine, e.g. the generator, the gear, etc.

Although the invention has been described above in connection with preferred embodiments of the invention, it will be evident for a person skilled in the art that several modifications are conceivable without departing from the invention as defined by the following claims.

1. A nacelle for a wind turbine, which nacelle has a height in its installed position, comprising:
a main frame structure,
a bottom part connected with the main frame structure and having a bottom face and two opposite side faces defining a space between the bottom and side faces and the bottom part width, and
a top part having a top face,
the faces together defining a nacelle cover within which wind turbine components can be housed,
wherein the nacelle cover has two intermediate parts intermediate the side faces and the top face.

2. The nacelle according to claim 1, wherein the top face is movable between a first position in which the nacelle has a first height and a second position in which the nacelle has a second height.

3. The nacelle according to claim 1, wherein at least one of the intermediate parts is adjustable to adjust a height of the intermediate part.

4. The nacelle according to claim 3, wherein the intermediate part comprises a displaceable second intermediate part arranged to move as a prolongation of the intermediate part in order to adjust the height of the intermediate part.

5. The nacelle according to claim 1, further comprising a support structure arranged in connection with the main frame structure to support the top face at least in the second height.

6. The nacelle according to claim 5, wherein the support structure is adjustable so as to adjust the height of the nacelle by moving the top part between the first and the second position.

7. The nacelle according to claim 1, wherein an internal overhung crane structure is part of the main frame structure.

8. The nacelle according to claim 5, wherein the support structure is individual rafters arranged at a predetermined distance along the side faces.

9. The nacelle according to claim 5, wherein the support structure has a predetermined height, either in order to fit a maximum transportation height defined by certain countriesy or in order to be able to fit a standard drive train into the nacelle.

10. The nacelle according to claim 1, wherein the first height is lower than the second height.

11. The nacelle according to claim 2, wherein the first height is a transportation height, e.g. below 3.3 metres.

12. The nacelle according to claim 2, wherein the second height is the height of the nacelle when installed.

13. The nacelle according to claim 1, wherein one side portion of intermediate parts is connected to the top part and an opposite side portion of the intermediate parts is slidable in relation to the side faces.

14. The nacelle according to claim 1, wherein the top face or a part of the top face is movable in relation to the intermediate parts.

15. A replacement kit comprising a bottom part and top part according to claim 1.

16. The replacement kit according to claim 15, further comprising a drive train part.

17. A replacement method for replacement of parts of a nacelle for a wind turbine, which nacelle has a height in its installed position, comprising:
a main frame structure,
a bottom part connected with the main frame structure and having a bottom face and two opposite side faces defining a space between the bottom and side faces and the bottom part width, and
a top part having a top face,
the faces together defining a nacelle cover within which wind turbine components can be housed,
wherein the nacelle cover has two intermediate parts intermediate the side faces and the top face, the method comprising the steps of:
detaching the two intermediate parts having a first height and
attaching two new intermediate parts having a second height.

18. The replacement method according to claim 17, further comprising the step of:
detaching the top part of the nacelle.

19. The replacement method according to claim 18, further comprising the step of:
detaching part of the drive train.
